(19) United States
(12) Patent Application Publication
(10) Pub. No.: US 2014/0274061 A1
(43) Pub. Date: Sep. 18, 2014

(54) ANR ESTABLISHMENT RESOLUTION

(71) Applicant: Yizhi Yao, Beijing (CN)

(72) Inventor: Yizhi Yao, Beijing (CN)

(73) Assignee: NOKIA SOLUTIONS AND NETWORKS OY, Espoo (FI)

(21) Appl. No.: 14/356,263

(22) PCT Filed: Nov. 4, 2011
(86) PCT No.: PCT/CN2011/081828

§ 371 Date: May 5, 2014

(51) Int. Cl. H04W 24/10; H04W 36/30

(52) U.S. Cl. CPC H04W 24/10; H04W 36/30
USPC 455/436

(57) ABSTRACT

The present invention provides a method, apparatus and a computer program product for ANR establishment resolution. The present invention includes receiving, at a base station, a measurement report from a user equipment including a signal strength from each of a plurality of cells, evaluating, at the base station, the signal strength from each of the cells, setting, at the base station, the cells with the signal strength exceeding a predetermined threshold, as neighbours for the cell serving the user equipment.

### FIELD OF THE INVENTION

The present invention relates to a quick ANR establishment resolution.

### BACKGROUND OF THE INVENTION

Automated neighbour relation (ANR) is an important and fundamental feature of self-organizing networks (SONs) in both LTE (long term evolution) and UMTS (universal mobile telecommunication service). With the ANR function, the network or SON server can automatically setup the neighbour relations based on the measurements reported from the user equipments (UEs). A good ANR function can significantly reduce the staff cost of manually configuring the neighbour relations to cells and therefore, such ANR function is highly desired by operators.

For both LTE (especially TD-LTE (time division LTE) and UMTS, the ANR capability is not yet fully supported by UEs so the ANR function cannot be efficiently implemented in the networks.

In the case of LTE, especially TD-LTE, it is difficult to support the inquiry of ECGI (E-UTRAN (evolved UMTS terrestrial radio access network) Cell Global-ID) for ANR in the standardized time frame. On the one hand, there are some technical difficulties involved, and on the other hand, the ANR function is not of great benefit for the UE.

In the case of UMTS, there are a lot of legacy UEs not supporting ANR function at all because ANR is a new feature for UMTS since Rel-10, so only very few number of UEs are expected to support ANR function.

If a UE does not support the E-UTRAN Cell Global ID inquiry, it can only report measurements to the serving cell, although it is capable of measuring reception of all the cells overlapping its current position.

With the problem above, the neighbour relations establishment for the networks will be surely very slow, thus the UEs (especially for the UEs not fully supporting ANR capability) would likely meet handover failure (call drop) due to insufficient neighbour relations.

In view of the above, it is desired to have a quick ANR establishment scheme in order to avoid the handover failures due to insufficiency of neighbour relations.

### SUMMARY OF THE INVENTION

According to the present invention, there are provided methods, apparatuses and a computer program product for ANR establishment resolution.

According to an aspect of the invention there is provided a method, comprising:
receiving, at a base station, a measurement report from a user equipment including a signal strength from each of a plurality of cells,
evaluating, at the base station, the signal strength from each of the cells,
setting, at the base station, the cells with the signal strength exceeding a predetermined threshold, as neighbours for the cell serving the user equipment.

According to further refinements of the invention as defined under the above aspects
the method further comprises forwarding, at the base station, the signal strength of each of the cells to an entity managing the respective cell.
Forwarding the signal strength of each of the cells can be before, after or in parallel with evaluating the signal strength of each of the cells.
Forwarding the signal strength of each of the cells can be before, after or in parallel setting the cells with the signal strength exceeding a predetermined threshold as neighbours for the cell serving the user equipment.
The base station forwards the signal strength of each of the cells the signal strength of which exceeding a predetermined threshold, to an entity managing the respective cell.

According to another aspect of the invention there is provided a method, comprising:
receiving, at a network entity, signal strengths of cells being managed by the network entity, from a base station which serves a cell serving user equipment, and
setting, at the network entity, the cells with the signal strength of which exceeding a predetermined threshold, as a neighbour for the cell serving the user equipment.

According to further refinements of the invention as defined under the above aspects
the network entity is another base station serving the cells.
the network entity is a self organizing network server, receiving the signal strength via an element manager of the base station serving the cells if the self organizing network server is separate from the element manager.
the network entity is a self organizing network server, receiving the signal strength via a network manager through an element manager of the base station serving the cells if the self organizing network server is separate from the network manager.
the predetermined threshold is set as an absolute value.
the predetermined threshold is set as a margin relative to the cell serving the user equipment.
the predetermined threshold is set by an OAM functionality.
the predetermined threshold is common for all cells.
the predetermined threshold is cell specific.
wherein forwarding of the signal strength of a cell is suspended in case the cell is already set as the neighbour of another cell.

According to an aspect of the invention there is provided a base station, comprising:
a receiving unit configured to receive a measurement report from a user equipment including a signal strength from each of a plurality of cells,
an evaluating unit configured to evaluate the signal strength from each of the cells, and
a setting unit configured to set the cells with the signal strength of which exceeding a predetermined threshold, as a neighbour for the cell serving the user equipment.

According to further refinements of the invention as defined under the above aspects
the base station further comprises a forwarding unit configured to forward the signal strength of each of these cells to an entity managing the respective cell.
Forwarding the signal strength of each of the cells can be before, after or in parallel with evaluating the signal strength of each of the cells.
Forwarding the signal strength of each of the cells can be before, after or in parallel setting the cells with the signal strength exceeding a predetermined threshold as neighbours for the cell serving the user equipment.
the forwarding unit is configured to forward the signal strength of each of the cells the signal strength of which exceeding a predetermined threshold, to an entity managing the respective cell.

According to an aspect of the invention there is provided a network entity, comprising:
a receiving unit configured to receive signal strengths of cells being managed by the network entity, from a base station which serves a cell serving user equipment, and
a setting unit configured to set the cells with the signal strength of which exceeding a predetermined threshold, as a neighbour for the cell serving the user equipment.

According to further refinements of the invention as defined under the above aspects
the network entity is another base station serving the cells.
the network entity is a self organizing network server, receiving the signal strength via an element manager of the base station serving the cells if the self organizing network server is separate from the element manager.
the network entity is a self organizing network server, receiving the signal strength via a network manager through an element manager of the base station serving the cells if the self organizing network server is separate from the network manager.
the predetermined threshold is set as an absolute value.
the predetermined threshold is set as a margin relative to the cell serving the user equipment.
the predetermined threshold is set by an OAM functionality.
the predetermined threshold is common for all cells.
the predetermined threshold is cell specific.
wherein the sending unit is configured to suspend forwarding of the signal strength of a cell in case the cell is already set as the neighbour of another cell.

According to an aspect of the invention there is provided a network entity, comprising:
a receiving unit configured to receive signal strengths of cells being managed by the network entity, from a base station which serves a cell serving user equipment, and
a forwarding unit configured to forward the signal strength of cells to another network entity managing the respective cell.

According to further refinements of the invention as defined under the above aspects
the network entity is an element manager managing the cells.
the network entity is a network manager managing the cells via an element manager.
the network entity is a self organizing network server.

According to another aspect of the present invention there is provided a computer program product comprising code means adapted to produce steps of any of the methods as described above when loaded into the memory of a computer.

According to a still further aspect of the invention there is provided a computer program product as defined above, wherein the computer program product comprises a computer-readable medium on which the software code portions are stored.

According to a still further aspect of the invention there is provided a computer program product as defined above, wherein the program is directly loadable into an internal memory of the processing device.

### BRIEF DESCRIPTION OF THE DRAWINGS

These and other objects, features, details and advantages will become more apparent from the following detailed description of embodiments of the present invention which is to be taken in conjunction with the appended drawings, in which:

FIG. 1 is a block diagram illustrating a SON architecture to which embodiments of the present invention are applicable;

FIG. 2 is a block diagram illustrating another SON architecture to which embodiments of the present invention are applicable;

FIG. 3 is a diagram showing a user equipment UE in relation to five cells C1 to C5.

FIG. 4 is a block diagram illustrating an example of an apparatus according to an embodiment of the present invention;

FIG. 5 is a flowchart illustrating processing of the apparatus according to an embodiment of the present invention.

FIG. 6 is a block diagram showing a network entity according to certain embodiments of the present invention.

FIG. 7 is a flowchart illustrating processing of the network entity according to certain embodiments of the present invention.

### DETAILED DESCRIPTION

In the following, embodiments of the present invention are described by referring to general and specific examples of the embodiments. It is to be understood, however, that the description is given by way of example only, and that the described embodiments are by no means to be understood as limiting the present invention thereto.

The idea underlying the present invention is utilizing the measurements report from one UE to establish neighbour relations for multiple cells. By this approach, the neighbour relation establishment time will be quicker at index level for the networks.

FIGS. 1 and 2 illustrate examples of SON architectures to which embodiments of the present invention are applicable. FIG. 1 shows a distributed architecture with an X2/Iur interface that connects two eNBs (enhanced NodeB) or RNCs (radio network controller) 11, 12 with each other, and which are further connected to an element manager EM 13. The eNBs 11, 12 can be managed by the same or different element managers.

FIG. 2 further shows an architecture which is distributed without an X2/Iur interface and a centralized architecture.

In distributed SON, the SON functions are located at the eNB 21, 22, and in the centralized SON, the SON functions are located at element manager 23, network manager (NM) or SON server 24.

FIG. 3 is a diagram showing a user equipment UE in relation to five cells C1 to C5 which are all overlapping the current position of the UE. In FIG. 3, it is assumed that cell C1 is the serving cell and that cells C1 and C2 are controlled by the same eNB (evolved NodeB), RNC (radio network controller), or BSC (base station controller). Further, it is assumed that in one measurement report, the measurement values of cells C1, C2, C3, C4 and C5 are all good enough, i.e. above a certain value, e.g. −80 dbm, or above a margin of C1, e.g. 2 dbm.

For simplicity, a blacklist of the neighbours is not considered in the following explanation.

According to the current standardized ANR capability, it is known that cells C2, C3, C4 and C5 can be the neighbours to the cell C1.

However, there is also a number of further possibilities.

Namely, the cell C1 can also be the potential neighbour to cells C2, C3, C4 and C5, respectively, and the cells C3, C4 and C5 can also be the potential neighbour to cell C2, because they are all measured with good signal strength. Further, vice versa, the cell C2 can be the potential neighbour for the cells C3, C4 and C5 and the potential neighbours for C3, C4 and C5, respectively, can be obtained in the same manner.

Thus, all of the cells with a good signal in one measurement report can be potential neighbours mutually for each other. That is, the measurements report from one UE is used to establish neighbour relations for multiple cells and not only to the serving cell. If, according to the measurement report received from the UE, cells C2, C3, C4, C5 can be neighbours to the serving cell C1, then all the cells can be potential neighbours for each other. By this way, the neighbour relations can be established much quicker than only setting up the neighbour relations to the serving cell, which in the present example would only be cell C1.

In the following, an example of an establishment of the neighbour relation will be described according to an embodiment of the present invention.

First, an UE measurements report is received by the eNB/RNC/BSC (the BSC is included here for future applicability to GSM) for the measured cells, including the serving cell, with good signal strength. Good signal strength means that the signal strength is above a certain threshold which can be an absolute value or a relative margin to the serving cell. The threshold can be common to all cells, or can be specific for each measured cell.

1) Then, for each cell (C1 and C2 respectively in the example mentioned above) including the serving cell which the eNB/RNC/BSC controls, the eNB/RNC/BSC set the other cells, which have good signal strength in the measurement report (for cell C1 they are C2, C3, C4 and C5, and for cell C2 they are C1, C3, C4 and C5, respectively), which meet its neighbour relationship condition (e.g., the signal strength reaches a certain value, or is above a certain margin to the respective cell) and do not already belong to its neighbour cells yet, to be its neighbours.
2) For the other cells (C3, C4 and C5 in the example) which are controlled by different eNBs/RNCs/BSCs, there is distinguished between three cases, namely distributed SON architecture with X2/Iur interface, distributed SON architecture without X2/Iur interface, and centralized SON architecture, as shown in FIGS. 1 and 2, respectively.
2a) In case of a distributed SON architecture for which the X2/Iur interface exists or can be established, the (serving) eNB/RNC informs the eNBs/RNCs controlling one or more of these cells (C3, C4 and C5 in the example) about this measurements value (with the global identity of each cell) over the X2/Iur interface, and then each of the receiving eNB/RNC will decide which cells will be added as neighbours.
2b) In case of a distributed SON architecture without a X2/Iur interface and for which X2 cannot be established, the (serving) eNB/RNC/BSC sends the same information as described above in the case of the X2/Iur interface to its element manager (EM), the EM then forwards this information to the eNBs/RNCs/BSCs controlling one or more of these cells (C3, C4 and C5 in the example). The EM can also forward this kind of information to the network manager (NM) if the EM does not control one or more of those eNBs/RNCs/BSCs and then the NM will forward this information to the target eNBs/RNCs/BSCs via their EMs.
2c) In case of a centralized SON architecture, the (serving) eNB/RNC/BSC sends the same information as described above in the case of the X2/Iur interface to its EM. In case of a SON server separated from EM, the EM then forwards this information to the SON server, and the EM may also forward this information to the NM if the SON server is at NM level and the NM will forward it to the SON server. Then the SON server will decide which cells will be added as neighbours for which ones.

For all of the above mentioned three cases 2a, 2b, and 2c, the OAM (operation, administration and maintenance) can set a configurable threshold (which can be an absolute value or relative margin to the serving cell) to control the UE measurements propagation. The threshold can be common for all the cells, and can also be cell-specific.

In order to improve the efficiency and signalling bandwidth, if the (serving) eNB/RNC/BSC knows if the measured cell are already the neighbour cell of one measured cell controlled by another eNB/RNC/BSC (e.g., by X2 update etc), the (serving) eNB/RNC/BSC may not send the measurement value to that eNB/RNC/BSC or EM.

It is noted that the above described embodiments apply to both intra-RAT (radio access technology) and inter-RAT ANR functionality.

In the following, examples for implementing the ANR establishment relation are described according to an embodiment of the present invention.

According to an embodiment, the invention is implemented in the eNB/RNC/BSC, EM, or a separate SON server.

In particular, the present invention is implemented on the eNB with support from management systems—EM and NM via Itf-N.

The following examples show in the typical format of a 3GPP 32.series, 36.series and 25.series stage 2 description how the above described solutions can be realized.

For case 1), no direct standards impact, but it can be measured when checking the air interface.

For case 2a), there is defined a new message as shown in the following in 36.423 for LTE, and 25.423 for UMTS, for example, in a section 9.1.2.x ‘UE Measurements For ANR’.

This message is sent by the eNB₁ to share the UE measurements for ANR collected by eNB₁ to eNB₂.

| IE/Group Name | IE type and reference | Semantics description |
|---|---|---|
| measResultListEUTRA | | |
| >ECGI | ECGI | E-UTRAN Cell Global Identifier of |
| | 9.2.14 | the measured cell |
| >PCI | INTEGER (0. . . 503, . . . ) | E-UTRAN Physical Cell Identifier |
| | | of the measured cell |
| >RSRP | RSRP-Range | |
| >RSRQ | RSRQ-Range | |
| measResultListUTRA | | |
| >cellGlobalId | cellGlobalIdUTRA | UTRAN Cell Global Identifier of |
| | | the measured cell |
| >physCellId | Choice of { | UTRAN Physical Cell Identifier of |
| | PhysCellIdUTRA-FDD, | the measured cell |
| | PhysCellIdUTRA-TDD} | |
| >RSCP | INTEGER (−5. . . 91) | |
| >EcN0 | INTEGER (0. . . 49) | |
| measResultListGERAN | | |
| >carrierFreq | CarrierFreqGERAN | Carrier frequency number of the |
| | | measured GERAN cell |
| >cellGlobalId | cellGlobalIdGERAN | GERAN Cell Global Identifier of |
| | | the measured cell |
| >physCellId | PhysCellIdGERAN | GERAN Physical Cell Identifier of |
| | | the measured cell |
| >rssi | INTEGER (0. . . 63) | |
| measResultListCDMA2000 | | |
| >cellGlobalId | cellGlobalIdCDMA2000 | CDMA2000 Cell Global Identifier |
| | | of the measured cell |
| >physCellId | PhysCellIdCDMA2000 | CDMA2000 Physical Cell |
| | | Identifier of the measured cell |
| >pilotPnPhase | INTEGER (0. . . 32767) | |
| >pilotStrength | INTEGER (0. . . 63) | |

For solution 2b) and 2c), a new IOC (e.g. UeMeasurementsForANR) is created in 32.762 and 32.642 to model the UE measurements for ANR as following:

| Attribute | Definition | Legal Values |
|---|---|---|
| measResultListEUTRA | List of measResultEutra | |
| | measResultEutra { | |
| | ECGI: ECGIEUTRA | |
| | PCI: integer | |
| | RSRP: integer | |
| | RSRP: integer | |
| | } | |
| | ECGIEUTRAN { | |
| | MCC: integer | |
| | MNC: integer | |
| | CellIdentity: integer | |
| | } | |
| measResultListUTRA | List of measResultUtra | |
| | List of measResultEutra | |
| | measResultUtra { | |
| | cellGlobalId: cellGlobalIdUTRA | |
| | physCellId: integer | |
| | RSCP: integer | |
| | EcN0: integer | |
| | } | |
| | cellGlobalIdUTRA { | |
| | MCC: integer | |
| | MNC: integer | |
| | CellIdentity: integer | |
| | } | |
| measResultListGERAN | List of measResultGeran | |
| | List of measResultGeran | |
| | measResultGeran { | |
| | CarrierFreqGERAN: CarrierFreqGERAN | |
| | cellGlobalId: cellGlobalIdGERAN | |
| | physCellId: integer | |
| | rssi: integer | |
| | } | |
| | cellGlobalIdGERAN { | |
| | MCC: integer | |
| | MNC: integer | |
| | LAC: integer | |
| | CellIdentity: integer | |
| | } | |
| | CarrierFreqGERAN { | |
| | Arfcn: integer | |
| | bandIndicator: integer | |
| | } | |
| measResultListCDMA2000 | List of measResultCdma2000 | |
| | List of measResultCdma2000 | |
| | measResultCdma2000 { | |
| | cellGlobalId: integer | |
| | physCellId: integer | |
| | pilotPnPhase: integer | |
| | pilotStrength: integer | |
| | } | |

For case 2b) and 2c), alternatively, the following paragraph “X” is added to 32.511,

### X ANR Architectures

The ANR function can be implemented in centralized architecture and distributed architecture.

To support the ANR functionality in the centralized architecture, or the distributed architecture without X2/Iur, the Subscriber and Equipment Trace functionality is reused to collect the measurement report made by UEs.

And the following use case for Trace is added to section 5.8 of 32.421.
Self-organizing Network supporting use cases cover situations where the operator is using the trace data to fulfill or support SON functionalities, a detailed case is:
Supporting ANR functionality using the traced measurement report.

For case 2d), the following attribute is added to the EUtranGenericCell or EUtranRelation/UtranRelation/GsmRelation/Cdma2000Relation IOC in 32.762, and UtranGenericCell and UtranRelation/EUtranRelation/GsmRelation/Cdma2000Relation IOC in 32.642.

| | | Legal |
|---|---|---|
| Attribute | Definition | Values |
| ThresholdForMeasurement- | Threshold used by the | |
| Propagation | serving eNB for controlling | |
| | the measurements value | |
| | propagation (to the subject | |
| | cell if it is in an EUtranRelation | |
| | IOC, UtranRelation IOC, | |
| | GsmRelation IOC or | |
| | Cdma2000Relation IOC). | |
| | The threshold can be an absolute | |
| | value, or a relative value to | |
| | the serving cell. | |

FIG. 4 is a block diagram showing a base station according to certain embodiments of the present invention.

As shown in FIG. 4, according to an embodiment of the present invention, the base station 40 comprises a receiving/sending unit 41 configured to receive a measurement report from a user equipment including a signal strength from each of a plurality of cells. Further, the base station 40 comprises an evaluating unit 42 configured to evaluate the signal strength from each of the cells and a setting unit 43. In case the cells, for which the measurements are provided, are served by the same base station, the setting unit 43 is configured to set the cells the signal strength of which exceeds a predetermined threshold, as a neighbour for the cell serving the user equipment.

According to another embodiment of the present invention, in case the cells are served by another base station, the sending unit 41 of the base station 40 is further configured to forward the signal strength of each of the cells to an entity managing the respective cell.

FIG. 5 is a flowchart illustrating processing of the base station according to certain embodiments of the present invention.

According to an embodiment of the present invention, first, in a step S51, the base station receives a measurement report from a user equipment including a signal strength from each of a plurality of cells. Then, in a step S52, the base station evaluates the signal strength from each of the cells, and sets, in a step S53, the cells that are served by the base station and the signal strength of which exceeds a predetermined threshold, as a neighbour for the cell serving the user equipment, in case the cells, for which the measurements are provided, are served by the same base station.

According to another embodiment, in case the cells are served by another base station, the base station forwards, in a step S54, for each of the cells that are served by another base station and the signal strength of which exceeds a predetermined threshold, the signal strength of each of the cells to an entity managing the respective cell.

FIG. 6 is a block diagram showing a network entity according to certain embodiments of the present invention.

As shown in FIG. 6, according to an embodiment of the present invention, the network entity 60 comprises a receiving unit 61 configured to receive signal strengths of cells being managed by the network entity, from a base station which serves a cell serving user equipment, and a setting unit 62 configured to set the cells with the signal strength of which exceeding a predetermined threshold, as a neighbour for the cell serving the user equipment.

According to another aspect, the network entity comprises a forwarding unit 61 configured to forward the signal strength of cells to another network entity managing the respective cell.

FIG. 7 is a flowchart illustrating processing of the network entity according to certain embodiments of the present invention.

According to an embodiment of the present invention, first, in a step S71, the network entity receives signal strengths of cells being managed by the network entity, from a base station which serves a cell serving user equipment, and, in a step S72, the network entity sets the cells with the signal strength of which exceeding a predetermined threshold, as a neighbour for the cell serving the user equipment.

According to another aspect, the network entity forwards the signal strength of cells to another network entity managing the respective cell in a step S73.

In the foregoing exemplary description of the base station and the network entity, only the units that are relevant for understanding the principles of the invention have been described using functional blocks. The base station may comprise further units that are necessary for its respective operation.

However, a description of these units is omitted in this specification. The arrangement of the functional blocks of the devices is not construed to limit the invention, and the functions may be performed by one block or further split into sub-blocks.

For the purpose of the present invention as described herein above, it should be noted that
method steps likely to be implemented as software code portions and being run using a processor at a radio access node, base station, element manager, network manager, SON server or user equipment (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses and user equipments, or any one of their respective units/means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

It is noted that the embodiments and general and specific examples described above are provided for illustrative purposes only and are in no way intended that the present invention is restricted thereto. Rather, it is the intention that all variations and modifications which fall within the scope of the appended claims are covered.

1. A method, comprising:
receiving, at a base station, a measurement report from a user equipment including a signal strength from each of a plurality of cells,
evaluating, at the base station, the signal strength from each of the cells,
setting, at the base station, the cells with the signal strength exceeding a predetermined threshold, as neighbours for the cell serving the user equipment.

2. A method according to claim 1, further comprising:
forwarding, at the base station, the signal strength of each of the cells to an entity managing the respective cell.

3. A method according to claim 1, wherein:
forwarding the signal strength of each of the cells can be before, after or in parallel with evaluating the signal strength of each of the cells.

4. A method according to claim 1, wherein:
forwarding the signal strength of each of the cells can be before, after or in parallel setting the cells with the signal strength exceeding a predetermined threshold as neighbours for the cell serving the user equipment.

5. A method according to claim 2, wherein:
the base station forwards the signal strength of each of the cells the signal strength of which exceeding a predetermined threshold, to an entity managing the respective cell.

6. A method comprising:
receiving, at a network entity, signal strengths of cells being managed by the network entity, from a base station which serves a cell serving user equipment, and
setting, at the network entity, the cells with the signal strength of which exceeding a predetermined threshold, as a neighbour for the cell serving the user equipment.

7. The method according to claim 6, wherein
the network entity is another base station serving the cells.

8. The method according to claim 6, wherein
the network entity is a self organizing network server, receiving the signal strength via an element manager of the base station serving the cells if the self organizing network server is separate from the element manager.

9. The method according to claim 6, wherein
the network entity is a self organizing network server, receiving the signal strength via a network manager through an element manager of the base station serving the cells if the self organizing network server is separate from the network manager.

10. The method according to claim 1, wherein
the predetermined threshold is set as an absolute value.

11. The method according to claim 1, wherein
the predetermined threshold is set as a margin relative to the cell serving the user equipment.

12. The method according to claim 1, wherein
the predetermined threshold is set by an OAM functionality.

13. The method according to claim 1, wherein
the predetermined threshold is common for all cells.

14. The method according to claim 1, wherein
the predetermined threshold is cell specific.

15. The method according to claim 1,
wherein forwarding of the signal strength of a cell is suspended in case the cell is already set as the neighbour of another cell.

16. A base station, comprising:
a receiving unit configured to receive a measurement report from a user equipment including a signal strength from each of a plurality of cells,
an evaluating unit configured to evaluate the signal strength from each of the cells, and
a setting unit configured to set the cells with the signal strength of which exceeding a predetermined threshold, as a neighbour for the cell serving the user equipment.

17. The base station according to claim 16, further comprising:
a forwarding unit configured to forward the signal strength of each of these cells to an entity managing the respective cell.

18. The base station according to claim 16, wherein:
forwarding the signal strength of each of the cells can be before, after or in parallel with evaluating the signal strength of each of the cells.

19. The base station according to claim 16, wherein:
forwarding the signal strength of each of the cells can be before, after or in parallel setting the cells with the signal strength exceeding a predetermined threshold as neighbours for the cell serving the user equipment.

20. The base station according to claim 17, wherein:
the forwarding unit is configured to forward the signal strength of each of the cells the signal strength of which exceeding a predetermined threshold, to an entity managing the respective cell.

21. A network entity, comprising:
a receiving unit configured to receive signal strengths of cells being managed by the network entity, from a base station which serves a cell serving user equipment, and
a setting unit configured to set the cells with the signal strength of which exceeding a predetermined threshold, as a neighbour for the cell serving the user equipment.

22. The network entity according to claim 21, wherein
the network entity is another base station serving the cells.

23. The network entity according to claim 21, wherein
the network entity is a self organizing network server, receiving the signal strength via an element manager of the base station serving the cells if the self organizing network server is separate from the element manager.

24. The network entity according to claim 21, wherein
the network entity is a self organizing network server, receiving the signal strength via a network manager through an element manager of the base station serving the cells if the self organizing network server is separate from the network manager.

25. The network entity according to claim 16, wherein
the predetermined threshold is set as an absolute value.

26. The network entity according to claim 16, wherein
the predetermined threshold is set as a margin relative to the cell serving the user equipment.

27. The network entity according to claim 16, wherein
the predetermined threshold is set by an OAM functionality.

28. The network entity according to claim 16, wherein
the predetermined threshold is common for all cells.

29. The network entity according to claim 16, wherein
the predetermined threshold is cell specific.

30. The network entity according to claim 16,
wherein the sending unit is configured to suspend forwarding of the signal strength of a cell in case the cell is already set as the neighbour of another cell.

31. A network entity, comprising:
a receiving unit configured to receive signal strengths of cells being managed by the network entity, from a base station which serves a cell serving user equipment, and
a forwarding unit configured to forward the signal strength of cells to another network entity managing the respective cell.

32. The network entity according to claim 31, wherein
the network entity is an element manager managing the cells.

33. The network entity according to claim 31, wherein
the network entity is a network manager managing the cells via an element manager.

34. The network entity according to claim 31, wherein
the network entity is a self organizing network server.

35. A computer program product including a program for a processing device, comprising software code portions for performing the steps of claim 1 when the program is run on the processing device.

36. The computer program product according to claim 35, wherein the computer program product comprises a computer-readable medium on which the software code portions are stored.

37. The computer program product according to claim 35, wherein the program is directly loadable into an internal memory of the processing device.
